(19) United States
(12) Patent Application Publication
(10) Pub. No.: US 2026/0194211 A1
(43) Pub. Date: Jul. 9, 2026

(54) A MICRO-OPTICAL STRUCTURE AND A METHOD FOR FORMING A MICRO-OPTICAL STRUCTURE

(71) Applicant: Massachusetts Institute of Technology, Cambridge, MA (US)

(72) Inventors: Luigi RANNO, Cambridge, MA (US); Tian GU, Cambridge, MA (US); Jurgen MICHEL, Cambridge, MA (US); Juejun HU, Cambridge, MA (US); Shuyu BAO, Singapore (SG); Kenneth Eng Kian LEE, Singapore (SG); Xueying ZHAO, Cambridge, MA (US); Jing NIU, Singapore (SG)

(21) Appl. No.: 19/129,630

(22) PCT Filed: Nov. 16, 2023
(86) PCT No.: PCT/US2023/080179

§ 371 Date: May 13, 2025

Related U.S. Application Data
(60) Provisional application No. 63/425,833, filed on Nov. 16, 2022.

(51) Int. Cl. F21V 13/04; F21V 5/04; F21V 7/00; F21V 7/06

(52) U.S. Cl. CPC F21V 13/04; F21V 5/04; F21V 7/0091; F21V 7/06

(57) ABSTRACT

A micro-optical structure for a micro-scale light source having an emitting surface for emitting light is described. The micro-optical structure comprises a reflective portion formed on the emitting surface of the micro-scale light source, where the reflective portion is adapted to reflect light emitted from the micro-scale light source out of the micro-optical structure. A method for forming a micro-optical structure is also described.

### TECHNICAL FIELD

The present disclosure relates to a micro-optical structure and a method for forming a micro-optical structure, particularly for a micro-scale light source.

### BACKGROUND

Light Emitting Diodes (LEDs) have revolutionized the field of lighting thanks to their exceptional efficiency when compared to incandescent or compact fluorescent lamps, and now high-performance LEDs have become a commodity article in spite of the incredible technological challenges associated with their production. Nevertheless, the miniaturization of LEDs, which is essential to improving both the efficiency of the device and the maximum resolution/channel density that are crucial to applications such as displays, illumination, and communication systems, comes with major challenges associated with light manipulation and device packaging. This is because conventional LED optics designs as well as limited resolution of the standard manufacturing methods used to produce such optics, e.g. compression-molding, are not fully compatible with the miniaturization of LEDs.

Optical components integrated with LEDs play a key role in providing important optical functions such as controlling the light output characteristics, improving the extraction efficiency by beam shaping and reducing the reflection at the interface between the bare semiconductor die and air. From mechanical aspects, they also provide packaging functions of the electronic chips which is essential for accessing the devices without damaging them.

As the LED industry is shifting toward smaller footprint micro-LEDs, major challenges associated with optical components and/or device packaging are presenting themselves. For instance, reducing the LED size reduces fabrication tolerances which lead to rougher sidewalls and up to 10-fold reductions in external quantum efficiency for LED sizes below 5 μm as compared to macro-sized (more the 500 μm) ones. A further issue comes from the limitations of the current manufacturing methods used to produce collimating optics. There have been attempts at manufacturing micro-lens arrays on a large scale, but that approach heavily limits the shapes that can be manufactured and thus the capabilities to reshape the LED light output. Even though some considerations have been made in terms of device design to mitigate these effects by, for example, adding a sloped sidewall or using a flip-chip configuration, the design of the supporting optics is far from mature. It is therefore desirable to provide a micro-optical structure and a method for forming a micro-optical structure which address the aforementioned problems and/or provides a useful alternative.

Furthermore, other desirable features and characteristics will become apparent from the subsequent detailed description and the appended claims, taken in conjunction with the accompanying drawings and this background of the disclosure.

### SUMMARY

Aspects of the present application relate to a micro-optical structure and a method for forming a micro-optical structure, particularly for a micro-scale light source. In accordance with a first aspect, there is provided a micro-optical structure for a micro-scale light source having an emitting surface for emitting light, the micro-optical structure comprising: a reflective portion formed on the emitting surface of the micro-scale light source, wherein the reflective portion is adapted to reflect light emitted from the micro-scale light source out of the micro-optical structure.

By having a reflective portion adapted to reflect light emitted from a micro-scale light source out of the micro-optical structure, the micro-optical structure enables an efficient extraction and reshaping of the light output from the micro-scale light source (e.g. a micro light emitting diode (LED)). The reflective portion can be designed based on freeform micro-optics which are adapted to effectively extract and manipulate light emitted not only from a top surface but also edges of the micro-scale light source. This is particularly useful considering that a size reduction of a light source (e.g. a LED) would lead to an increase of the fractional side-wall area of the light source. This aids to improve efficiency of the micro-scale light source by reducing the amount of light lost through light emission at unwanted directions or reflected back into the substrate. This in turn results in a lower current requirement, and thus a reduced power consumption and an easier thermal management of the micro-scale light source. This micro-optical structure can also be integrated with a micro-scale light source for enabling enhanced optical performance and packaging capabilities, thereby solving optical packaging challenges associated with the manufacturing of micro-scale light sources (e.g. micro-LEDs).

The micro-optical structure may comprise a top lens formed on the reflective portion, wherein the reflective portion is adapted to reflect light emitted from the micro-scale light source towards the top lens, and the top lens is adapted to redirect the reflected light from the reflective portion to be emitted out of the micro-optical structure.

The reflective portion may be tapered. The reflective portion may comprise a compound parabolic concentrator (CPC). The reflective portion may be adapted to operate based on total internal reflection or use of reflective coatings. The reflective portion may be divided into two or more sections adapted to provide different optical functions for light emitted from different portions of the micro-scale light source. A cross-section of the reflective portion may include one of: an octagonal shape, a square shape and a circular shape. It should be appreciated that other geometrical shapes are possible and full free-form design of the reflective portion, or the reflective portion and the top lens, can lead to other types of cross sections which are not simple geometrical shapes.

The top lens may include one of: an anamorphic aspherical lens, a conical lens and a toroidal lens. It should be appreciated that other lens designs are possible depending on an intended application of the top lens.

The micro-optical structure may extend substantially normally from the emitting surface of the micro-scale light source. An aspect ratio of a width to a height of the micro-optical structure may range from 1:0.1 to 1:100. Dimensions of the reflective portion or the reflective portion and the top lens may be optimized based on maximizing a total intensity and minimizing a full width half maximum (FWHM) of the redirected light emitted out of the micro-optical structure.

The micro-optical structure may be adapted to integrate with the micro-scale light source. The reflective portion may be adapted to enclose the emitting surface and exposed edge surfaces of the micro-scale light source. This improves the efficiency of light emission from the micro-scale light source because light which would otherwise be lost through the exposed edge surfaces (e.g. side walls) of the micro-scale light source can be captured and transmitted through the micro-optical structure.

In accordance with a second aspect, there is provided a micro-scale optical system comprising a micro-scale light source and any one of the aforementioned micro-optical structure, wherein the micro-optical structure is integrated with the micro-scale light source.

The micro-scale light source may include one of: a light emitting diode (LED) and a vertical cavity surface emitting laser (VCSEL).

In accordance with a third aspect, there is provided a computer readable medium storing computer executable instructions that, when executed by a processor, cause the processor to control an additive manufacturing apparatus to manufacture any one of the aforementioned micro-optical structure.

In accordance with a fourth aspect, there is provided a method for forming a micro-optical structure for a micro-scale light source having an emitting surface for emitting light, the method comprising: forming a reflective portion of the micro-optical structure on the emitting surface of the micro-scale light source, wherein the reflective portion is adapted to reflect light emitted from the micro-scale light source out of the micro-optical structure. The method may comprise forming a top lens on the reflective portion, wherein the reflective portion is adapted to reflect light emitted from the micro-scale light source towards the top lens, and the top lens is adapted to redirect the reflected light from the reflective portion to be emitted out of the micro-optical structure.

The reflective portion and the top lens may be formed using a two-photon polymerization (TPP) process.

The method may comprise: obtaining an electronic file representing a geometry of the micro-optical structure; aligning an additive manufacturing apparatus for forming the micro-optical structure using a sidewall of the micro-scale light source; and controlling the additive manufacturing apparatus to form, over one or more additive manufacturing steps, the micro-optical structure according to the geometry specified in the electronic file.

The method may comprise: forming the reflective portion or the reflective portion and the top lens taking into account a geometry of the micro-scale light source for maximizing a total intensity and minimizing a full width half maximum (FWHM) of the redirected light emitted out of the micro-optical structure.

The reflective portion and the top lens may be formed using nano-imprinting, hot embossing, greyscale lithography or molding.

The method may comprise: forming the reflective portion to enclose the emitting surface and exposed edge surfaces of the micro-scale light source.

Embodiments therefore provide a micro-optical structure and a method for forming a micro-optical structure, particularly for a micro-scale light source. In an exemplary embodiment, by having a reflective portion adapted to reflect light emitted from a micro-scale light source towards a top lens, and the top lens adapted to redirect the reflected light from the reflective portion to be emitted out of the micro-optical structure, the micro-optical structure enables an efficient extraction and reshaping of the light output from the micro-scale light source (e.g. a micro light emitting diode (LED)). The reflective portion or the reflective portion and the top lens can be designed based on freeform micro-optics which are adapted to effectively extract and manipulate light emitted not only from the top surface but the edges of micro-scale light source. This aids to improve efficiency of the micro-scale light source by reducing the amount of light lost through light emission at unwanted directions or reflected back into the substrate. This in turn results in a lower current requirement, and thus a reduced power consumption and an easier thermal management of the micro-scale light source. This micro-optical structure can also be integrated with a micro-scale light source for enabling enhanced optical performance and packaging capabilities, thereby solving optical packaging challenges associated with the manufacturing of micro-scale light sources (e.g. micro-LEDs). Moreover, formation of the micro-optical structure can be easily scaled up to high-volume manufacturing. For example, upscaling of the manufacturing of this micro-optical structure can be through the use of nano-imprinting, hot embossing, greyscale lithography or molding for high-volume, low-cost replication of 2-D micro-optics arrays.

### BRIEF DESCRIPTION OF THE DRAWINGS

Embodiments will now be described, by way of example only, with reference to the following drawings, in which:

FIGS. 1A and 1B show diagrams in relation to light emitting diode (LED) technology of the prior art, where FIG. 1A show diagrams in relation to far field light emission pattern of LEDs with different surfaces, and FIG. 1B shows a diagram of a packaged LED module and its main components;

FIG. 2 shows a schematic of a micro-optical structure being applied on a micro-scale light source (in this case, a micro-LED) in accordance with an embodiment;

FIG. 3 shows diagrams of far field emission profiles of (a) a bare micro-LED and (b) a micro-LED with a micro-optical structure in accordance with an embodiment;

FIGS. 4A and 4B show diagrams of exemplary optimized micro-optical structures and emission intensities of micro-LEDs using exemplary optimized micro-optical structures in accordance with embodiments, where FIG. 4A shows diagrams of 3D rendering of exemplary optimized micro-optical structures and FIG. 4B shows a diagram of angular emission intensity in (W/Sr) for different micro-optical structures (the out-of-plane vertical axis is at 90°);

FIGS. 5A and 5B show micrographs before and after powering of micro-LEDs in accordance with an embodiment, where FIG. 5A shows a micrograph before powering the micro-LEDs and FIG. 5B shows a micrograph after powering the micro-LEDs;

FIGS. 6A, 6B, 6C and 6D show examples of a micro-optical structure in accordance with embodiments, where FIG. 6A shows a three-dimensional (3D) model of a micro-optical structure, FIG. 6B shows a scanning electron microscopy (SEM) micrograph of a reflector with a square cross section and dimensions of 110 μm in height and 36 μm in width, FIG. 6C shows a SEM micrograph of micro-optical structures with square cross-sections and FIG. 6D shows a SEM micrograph of micro-optical structures with octagonal cross sections;

FIGS. 7A and 7B show optical micrographs under a 5×0.14NA microscope of micro-LEDs before and after forming of micro-optical structures in accordance with an embodiment, where FIG. 7A shows an optical micrograph of the micro-LEDs before forming of the micro-optical structures and FIG. 7B shows an optical micrograph of the micro-LEDs after forming of the micro-optical structures; and

FIG. 8 shows a plot of enhancement factor (EF) for different micro-optical structures printed on 6 μm×6 μm (cross data points), and 18 μm×18 μm (diamond data points) micro-LEDs in accordance with embodiments.

### DETAILED DESCRIPTION

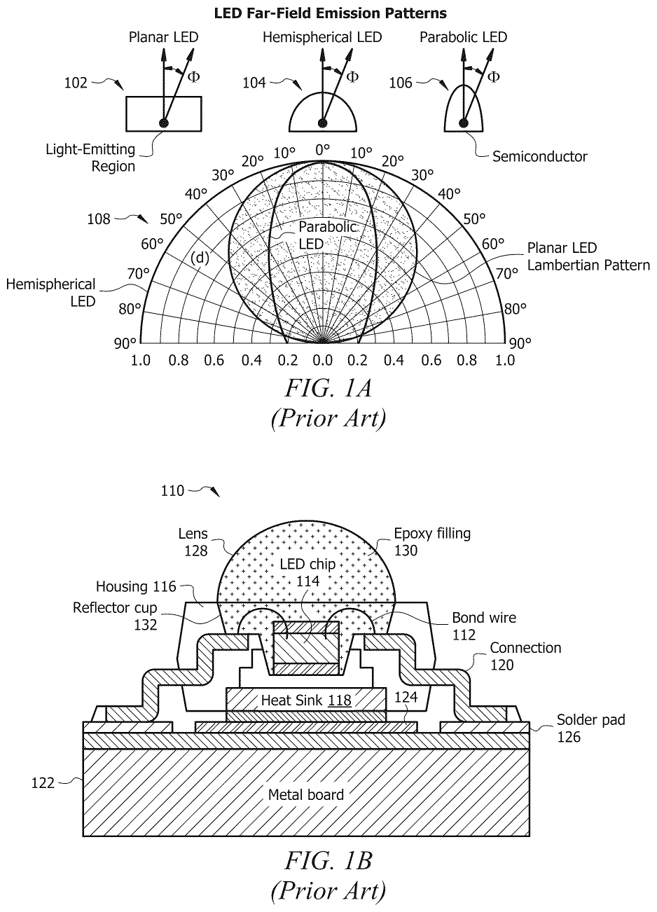

Exemplary embodiments relating to a micro-optical structure and a method for forming a micro-optical structure, particularly for a micro-scale light source, are described. FIGS. 1A and 1B relate to existing art for showing limitations in the present LED packaging and/or optical components. FIG. 1A show diagrams in relation to far field light emission pattern of LEDs with different surfaces. These far field emission patterns of LEDs were retrieved from the Zeiss Microscopy Online Campus (http://zeiss-campus.magnet.fsu.edu/articles/lightsources/leds.html). For example, as shown in FIG. 1A, a planar LED 102, a hemispherical LED 104 and a parabolic LED 106 are shown. The different far field emission patterns of these different LEDs are shown in a plot 108 for reference. The plot 108 shows some examples of possible far-field angular emission profiles by simple encapsulation in the present art. LED packaging has evolved substantially over the years from simple encapsulation using hemispherically-shaped plastic caps into a complex sequence of steps intend to optimize the optical, electrical, and thermal performance of the LEDs.

Modern LED packages are produced sequentially, for example, by: (i) placement of a LED chip on a pre-shaped main frame, (ii) bonding of the LED chip to a central frame, which functions as an heat sink, (iii) wire bonding of the LED chip to a lead-frame (e.g. shown as “bond wire” 112 in FIG. 1B), (iv) placement of a molded plastic lens (typically polycarbonate) on top of the LED chip, and (v) filling the molded lens with a silicone gel or epoxy filling. FIG. 1B shows a diagram of a cross-section of a packaged LED module 110 and its main components (schematic adapted from Liu, S. & Luo, X. “LED packaging for lighting applications: design, manufacturing, and testing”, Wiley, 2011, DOI: 10.1002/9780470827857) as an example.

The packaged LED module 110 includes a LED chip 114 placed within a housing 116 and attached to a heat sink 118 placed on a pre-shaped frame which includes pre-formed electrical connections 120. The heat sink 118 is in turn formed on a metal board 122 via soldering 124. The LED chip 114 is connected to the pre-formed electrical connections 120 via bond wires 112, and the pre-formed electrical connections 120 are in turn connected to the metal board 122 via solder pads 126. A molded plastic lens 128 having epoxy filling 130 is placed on top of the LED chip 114 and a reflector cup 132 as shown in FIG. 1B.

In order to address the optical and packaging challenges introduced above, novel micro-optics or micro-optical structures which can be integrated on top of micro-LEDs are proposed in the present disclosure. Embodiments of these micro-optical structures can be tailored to enhance optical performances of the micro-LEDs along with providing packaging advantages. For prototyping, the two-photon polymerization (TPP) method was used for fabricating the micro-optical structures. The proposed application capitalizes on the design freedom and low surface roughness provided by TPP to produce optimized structures tailored to the specifics of each micro-scale device.

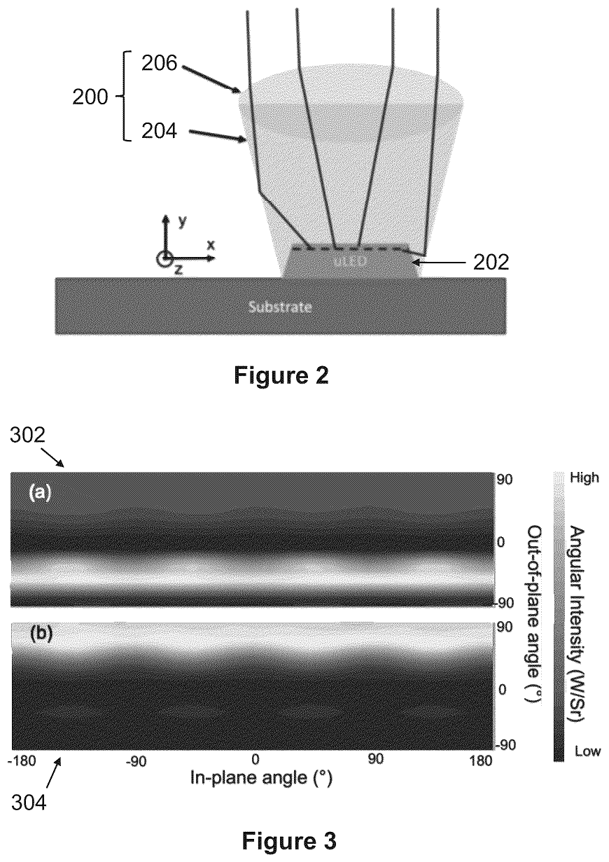

An embodiment of a micro-optical structure of the present disclosure is shown in relation to FIG. 2. FIG. 2 shows a schematic of a micro-optical structure 200 being applied on a micro-scale light source 202 (in this case, a micro-LED). As shown in FIG. 2, the micro-optical structure 200 can be divided into two parts: a bottom reflective portion such as a reflective cone 204 as shown (one example may be a compound parabolic concentrator (CPC)) and a top lens 206 or a front lens provided on top of or above the reflective cone 204. The reflective cone 204 can be either based on total internal reflection (TIR) or reflective coatings. The reflective coatings may include high-k transparent dielectrics or thin metallic films. These can be used to improve reflectivity by coating a fabricated reflective cone using atomic layer deposition (ALD) or similar conformal deposition methods. The reflective cone 204 may be further divided into at least two sections, which provide different optical functions (e.g., redirecting, collimating, focusing, reshaping, reflecting etc.) for light emitted from different portions of the micro-LED. The reflective cone 204 and the top lens 206 are collectively designed to reshape the emitted light. The micro-optical structure may also be co-designed with a geometry of the micro-LED 202 (e.g., its sidewall angle) for desired optical performances. The reflective cone 204 and the top lens 206 may be formed using one or more of: organo-ceramics, acrylate-based negative resists, epoxies, thermoplastics and silicones (for large scale replications). In an embodiment, the reflective cone 204 reflects and/or redirects the light emitted from the micro-LED's top and edge surfaces towards a top of the micro-optics, that is, towards the top lens 206 of the micro-optical structure 200. The top lens 206 further improves the collimation and light extraction performance and reduce a total device size or a package size. For example, the top lens 206 can correct for an imperfect collimation created by the reflective cone 204 and/or be used to reshape the light output in other ways (e.g. focusing the light to a point above the surface). Freeform optimization of the entire structure is also possible in a subsequent step to further improve the device performance.

One significant advantage of using a micro-optical structure 200 of the present embodiments is that it allows to extract, redirect, and/or collimate a large portion of the light emitted from the micro-LED sidewalls, leading to significant improvements in a total efficiency of the micro-LED structure and output beam characteristics. In addition, the proposed use of the micro-optical structure 200 can also be easily scaled up through standard means by making reusable molds through, as an example, injection molding, hot embossing or nanoimprint lithography, allowing large-area, low-cost replication of 2-D micro-optics arrays.

Although FIG. 2 shows an embodiment where the reflective cone 204 of the micro-optical structure 200 is adapted to enclose the emitting surface and exposed edge surfaces of the micro-scale light source 202, it is not strictly necessary or essential. In other embodiments, a reflective cone can be formed on the emitting surface of the micro-scale light source with a top lens formed on the reflective cone, where the reflective cone is adapted to reflect light emitted from the micro-scale light source towards the top lens, and the top lens is adapted to redirect the reflected light from the reflective cone to be emitted out of the micro-optical structure.

FIGS. 3 to 8 below provide exemplary results in relation to prototyping of micro-optical structures in accordance with embodiments of the present disclosure.

It should be appreciated that the micro-optical structure and method for forming the micro-optical structure disclosed are particularly applicable to micro-scale surface-normal light sources (e.g., LEDs, VCSELs, etc.) and can be easily extended to a wide range of wavelengths (ranging from the near-UV to the infrared). In the present embodiment, for prototyping, the micro-LEDs used are produced in uniform arrays having 20 μm spacing between neighboring micro-LEDs and mesa sizes in the range of 6 μm to 300 μm. The micro-optical structure can be designed and modeled using ray-tracing, taking into account a configuration of the micro-LED device in question (e.g., side wall angles of the micro-LED, a multi-quantum well (MQW) thickness, etc.). For example, designs of the micro-optical structure can initially be formed analytically, where an appropriate shape for analytically defined surfaces of the micro-optical structure (e.g. the CPC) can be chosen based on a geometry (e.g. sidewalls, material stack etc.) of the micro-LED device. Using this initial analytically defined micro-optical structure, a suitable optimization scheme can be introduced to optimize the micro-optical structure. For example, optimization schemes such as particle swarm, simulated anneal, cross-entropy or differential evolution or other schemes that can work with non-differentiable objective functions that are not strictly unimodal etc. can be used. Use of an optimization scheme is helpful, particularly in the case of a free-form design where the parameter space is too large to be optimized individually. An optimization algorithm or scheme may be provided in an optical simulation software (e.g. Synopsys LightTools) which can be used to estimate the performance of the micro-optical structure, based on e.g. particle swarm optimization. In the present embodiments, an optimal geometry of a reflective cone and a top lens of a micro-optical structure can be found by (i) maximizing a total intensity of the light going up (integrated over a surface spanning ±30° from the vertical axis), as a figure of merit for improvement in the extraction efficiency, and/or (ii) minimizing a full width at half maximum (FWHM) of the vertical beam, as a figure of merit for the degree of collimation achieved by the micro-optical structure. To do this, first, a three-dimensional (3D) geometry of the micro-optical structure is defined in the software through a list of many parameters that fully define the 3D shape (either a complete set of points for fully free-form designs, or parameters to analytically define the shape). Then, various combinations of parameters (referred to as “particles”) are initialized. The “particles” are allowed to explore the solution space as if subjected to different forces (e.g. (i) wanting to go back to its personal best position, (ii) wanting to go to the best global solution achieved yet, (iii) friction slowing the particle down etc.). The micro-optical structures corresponding to the state of each “particle” is simulated and evaluated based on the figures of merit described above. After a certain number of iterations, the algorithm will have converged to a micro-optical structure that is optimal, given the starting configuration of solutions that was initialized. The optimized 3D geometry of the micro-optical structure can then be converted into a 3D geometric file, e.g. a STL file, or recreated in the CAD software for a subsequent process. The optimization algorithm is constrained to avoid solutions where the dimensions of the micro-optical structure would exceed a pitch of the micro-LED grid, as that would result in structural overlap and loss of performance upon fabrication, or structures with excessively high aspect ratios. A similar optimization approach can be used to produce micro-optical structures for different desired far field profiles of the micro-LED. FIG. 3 shows diagrams of (a) a far field emission profile 302 of a bare micro-LED and (b) a far field emission profile 304 of a micro-LED with a micro-optical structure, in accordance with an embodiment. FIG. 3 illustrates an example of a difference in angular emission between a bare micro-LED structure and a micro-LED embedded inside a 110 μm tall micro-optical structure, where the micro-optical structure comprises a square cross-section CPC reflector (i.e. the reflective cone) with an anamorphic top lens. As shown in FIG. 3, in relation to the far field emission profile 302 of the bare micro-LED, a large amount of light is reflected back (see e.g. a high angular intensity band at ~−60° vertical). In contrast, as shown in the far field emission profile 304 of the micro-LED embedded in the micro-optical structure, the optical performance is vastly improved by reducing the back-reflection while also improving the collimation (see e.g. that most light of the far field emission profile 304 is emitted at) 60°~90°.

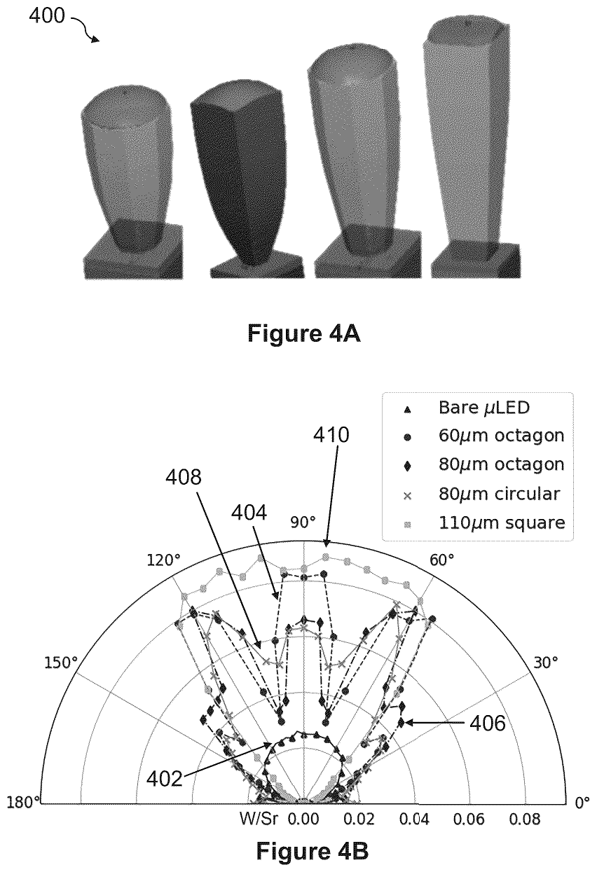

Depending on the performance and geometry requirements (e.g., a maximum aspect ratio allowed), a variety of top optical lenses (e.g. anamorphic aspheric, conic, toroidal lenses), or cross section of the reflective cone (e.g. octagonal, square, circular, hexagonal, triangular etc.) may be used. It is thereby possible to generate widely different structures in response to customizable requirements. Some exemplary structures with different maximum heights and cross-sections, along with their respective far field emission profiles, are displayed in FIGS. 4A and 4B.

FIGS. 4A and 4B show diagrams of exemplary optimized micro-optical structures and emission intensities of micro-LEDs using exemplary optimized micro-optical structures in accordance with embodiments. FIG. 4A shows diagrams 400 of 3D rendering of exemplary optimized micro-optical structures, where micro-optical structures comprising reflective cones of different cross-sections (e.g. octagonal, squarish etc.) and top lens of different shapes and/or dimensions are shown. FIG. 4A also shows that various dimensions of the micro-optical structure, e.g. width, length, diameter, height, a varying cross section from a bottom surface to a top surface of the micro-optical structure, a degree of tapering etc., can be adjusted and optimized depending on a requirement and configuration of the micro-LED. FIG. 4B shows a diagram of angular emission intensity in (W/Sr) for different micro-optical structures (the out-of-plane vertical axis is at) 90°. (i) An angular emission profile 402 for a bare micro-LED, (ii) an angular emission profile 404 for a micro-LED integrated with a 60 μm tall micro-optical structure comprising an octagonal cross-section CPC reflector (i.e. the reflective cone) with an anamorphic top lens, (iii) an angular emission profile 406 for a micro-LED integrated with a 80 μm tall micro-optical structure comprising an octagonal cross-section CPC reflector (i.e. the reflective cone) with an anamorphic top lens, (iv) an angular emission profile 408 for a micro-LED integrated with a 80 μm tall micro-optical structure comprising a circular cross-section CPC reflector (i.e. the reflective cone) with an anamorphic top lens, and (v) an angular emission profile 410 for a micro-LED integrated with a 110 μm tall micro-optical structure comprising a square cross-section CPC reflector (i.e. the reflective cone) with an anamorphic top lens are shown in FIG. 4B.

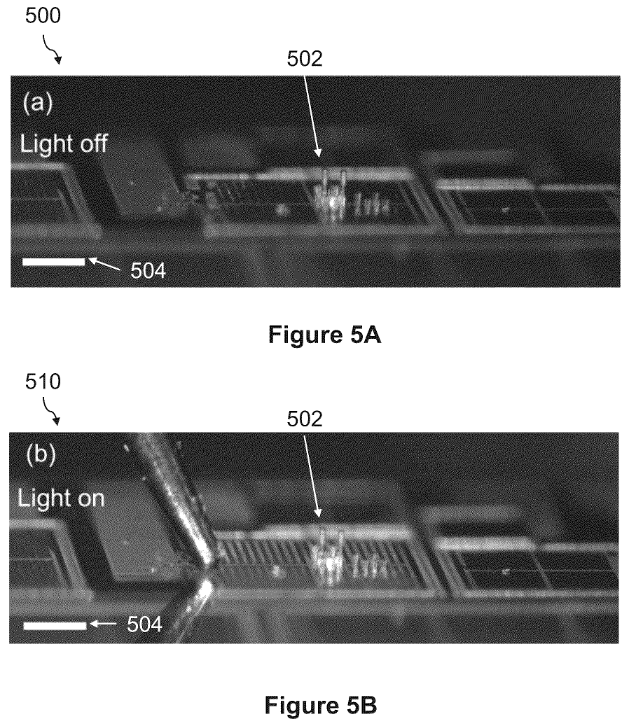

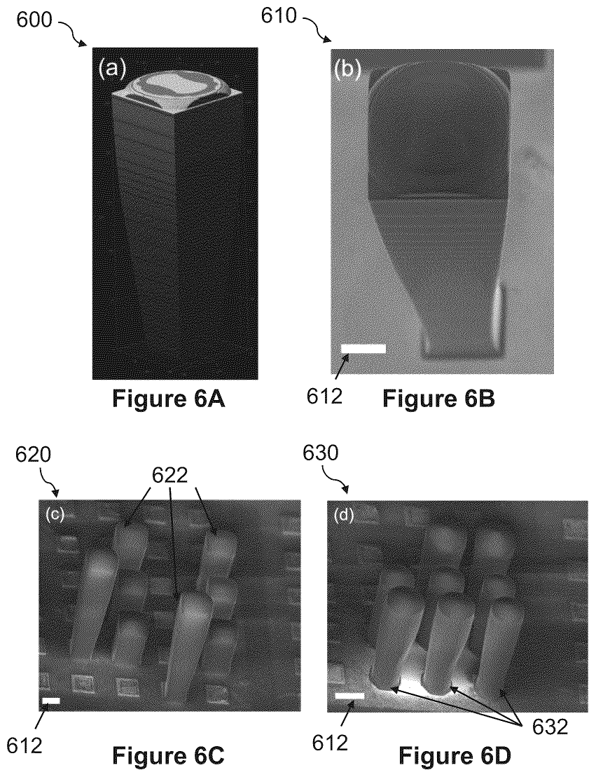

These prototype micro-optical structures were fabricated using the two-photon polymerization (TPP) method. Considering requirements such as materials transparency and printing resolution and surface roughness, potential choice of photo-resins include, but not limited to, Ormocomp from micro resist technology, or Nanoscribe's IP-Visio, IP-Dip, IP-n162, IP-G and GP-Silica, or SU-8 from Kakayu Advanced Materials, or polydimethylsiloxane (PDMS). Optical and Scanning Electron micrographs of various printed micro-optical structures are presented in relation to FIGS. 5A to 6D below. Initial optimization of the printing process using the TTP method shows that it is possible to print with the required resolution and surface smoothness.

FIGS. 5A and 5B show micrographs before and after powering of micro-LEDs in accordance with an embodiment, where FIG. 5A shows a micrograph 500 before powering the micro-LEDs and FIG. 5B shows a micrograph 510 after powering the micro-LEDs. The structures 502 as shown at the center of the micro-LED grid are examples of micro-optical structures comprising reflective cones and top lens fabricated using the TPP method. The scalebars 504 in each of the FIGS. 5A and 5B are 150 μm wide.

FIGS. 6A, 6B, 6C and 6D show examples of a micro-optical structure in accordance with embodiments. FIG. 6A shows a three-dimensional (3D) model 600 of a micro-optical structure, FIG. 6B shows a scanning electron microscopy (SEM) micrograph 610 of a reflector with a square cross section and dimensions of 110 μm in height and 36 μm in width, FIG. 6C shows a SEM micrograph 620 of micro-optical structures 622 with square cross-sections and FIG. 6D shows a SEM micrograph 630 of micro-optical structures 632 with octagonal cross sections. The scale bars 612 as shown in FIGS. 6B, 6C and 6D are each 10 μm wide.

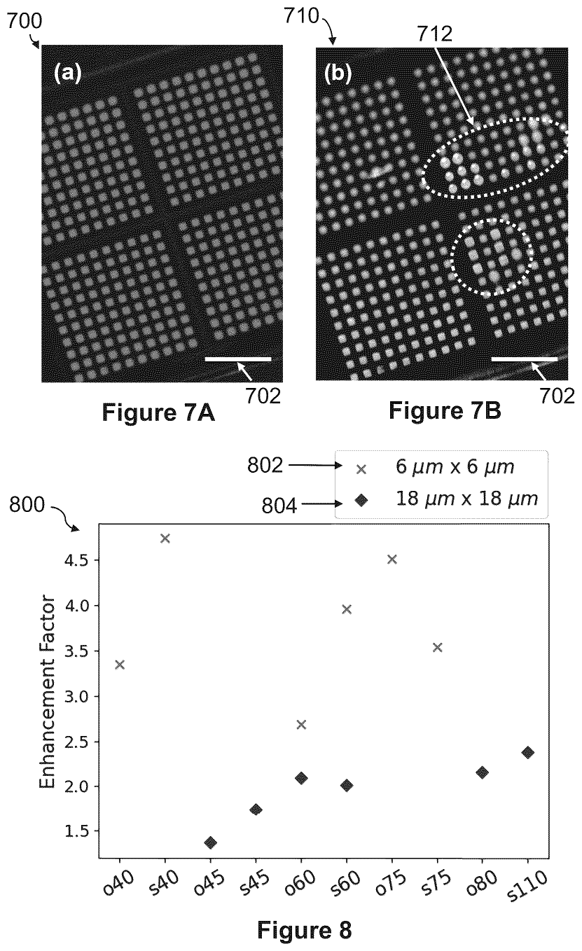

FIGS. 7A and 7B show optical micrographs of a micro-LED array before and after forming of micro-optical structures, under a 5×0.14NA microscope, in accordance with an embodiment. FIG. 7A shows an optical micrograph 700 of the micro-LEDs before forming of the micro-optical structures and FIG. 7B shows an optical micrograph 710 of the micro-LEDs after forming of the micro-optical structures. The scale bars 702 as shown in FIGS. 7A and 7B are 100 μm in length.

The optical micrographs of the micro-LED array before and after forming the micro-optical structures, as shown in relation to FIGS. 7A and 7B, indicate that the micro-optical structures can greatly improve the performance of the micro-LEDs in terms of optical extraction efficiency and collimation. This is for example shown by the brighter spots 712 provided by the micro-LEDs having the micro-optical structures in FIG. 7B. An enhancement factor (EF) is estimated, computed by comparing the light intensities of micro-LED pixels with and without the micro-optics, which is collected under the 0.14NA microscope.

FIG. 8 shows a plot 800 of enhancement factor (EF) for different micro-optical structures printed on 6 μm×6 μm (cross-shaped data points 802 on the plot 800), and 18 μm×18 μm (diamond-shaped data points 804 on the plot 800) micro-LEDs in accordance with embodiments. The x axis of the plot 800 of FIG. 8 identifies different micro-optical structures depending on their cross-section (‘o’ for an octagonal cross-section and ‘s’ for a square cross-section) and their maximum allowed height in microns used during the optimization process. More specifically, the numerals identified for the different micro-optical structures correspond to the maximum height the entire micro-optical structure was allowed to reach during the optimization process. It is necessary to include a constraint on the maximum height of the micro-optical structure, because otherwise the algorithm would converge onto structures that are very tall and taper very gradually. Theoretically, an infinitely long reflective cone could extract all the light with perfect efficiency. By adding the geometrical constraint, the problem of the algorithm converging onto structures that are very tall and taper very gradually is avoided, to ensure that the optimized micro-optical structures will be manufacturable. There is a tradeoff between the micro-optical structure size and the throughput, where bigger structures generally perform better but they take more space and require longer printing times.

As shown in FIG. 8, the EFs vary considerably depending on the size of the micro-LEDs and the geometry of the micro-optical structures, but could reach 3~4× for the best-performing designs on the 6 μm×6 μm LEDs and >2× for the 18 μm×18 μm LEDs, indicating enhanced light extraction and collimation performance. The higher effectiveness of the structures at smaller LED sizes can be explained by the fact that the smaller LEDs will lose proportionally more light through the side walls, where the micro-optical structures of the present embodiments enable effective capturing of the side-emitted light.

Micro-optical structures as aforementioned described are fabricated or formed using the two-photon polymerization (TPP) method but it should be appreciated that other suitable fabrication methods (e.g. molding) can be used. The TPP method is a three-dimensional (3D) microfabrication method based on additive manufacturing. It typically uses ultrashort laser pulses, which when focused into a volume of a photosensitive material (or photoresist or photoresin), the laser pulses initiate two-photon polymerization via two-photon absorption and subsequent polymerization. After illumination of the desired micro-optical structures inside a volume of the photosensitive material, the photosensitive material can be developed (e.g., washing out the non-illuminated regions) where the polymerized material remains formed the micro-optical structures for use with a micro-scale light source. The TPP method allows fabrication of any computer-generated 3-D structure by direct laser writing (DLW) into a volume of photosensitive material.

Steps taken in the present embodiments to improve formation of the micro-optical structures include: (i) identifying an interface of a chip for forming the micro-optical structures by focusing on an edge of the chip or at flat regions (e.g. metal contacts) on the chip for more accurately determining an interface of the chip; and/or (ii) aligning an additive manufacturing apparatus for forming the micro-optical structures using a sidewall or sidewalls of the micro-scale light source. Step (ii) may for example be used if it is desired e.g. to form a micro-optical structure at a specific height with respect to a base of the micro-scale light source (e.g. at the base of the micro-scale light source, or at half-way between the emitting surface and the base of the micro-scale light source along the side wall of the micro-scale light source).

Accordingly, examples described herein not only include the micro-optical structures as described herein, but also methods of manufacturing or forming such micro-optical structures via additive manufacturing and computer software, firmware or hardware for controlling the manufacture of such products via additive manufacturing.

As will be appreciated by the skilled person in the art, the micro-optical structures may be represented digitally in the form of a design file. A design file, or computer aided design (CAD) file, is a configuration file that encodes one or more of the surface or volumetric configuration of the shape of a product. That is, a design file represents the geometrical arrangement or shape of a product, which in the present disclosure, relates to a micro-optical structure.

Design files can take any now known or later developed file format. For example, design files may be in the Stereolithography or “Standard Tessellation Language” (.stl) format which was created for stereolithography CAD programs of 3D Systems, or the Additive Manufacturing File (.amf) format, which is an American Society of Mechanical Engineers (ASME) standard that is an extensible markup-language (XML) based format designed to allow any CAD software to describe the shape and composition of any three-dimensional object to be fabricated on any additive manufacturing printer.

Further examples of design file formats include AutoCAD (.dwg) files, Blender (.blend) files, Parasolid (.x_t) files, 3D Manufacturing Format (0.3 mf) files, Autodesk (3 ds) files, Collada (.dae) files and Wavefront (.obj) files, although many other file formats exist. Design files can be produced using modeling (e.g. CAD modeling) software. Once obtained, a design file may be converted into a set of computer executable instructions that, once executed by a processer, cause the processor to control an additive manufacturing apparatus (e.g. a two-photon lithography system) to produce a product according to the geometrical arrangement specified in the design file. The conversion may convert the design file into slices or layers that are to be formed sequentially by the additive manufacturing apparatus. The instructions (otherwise known as geometric code or “G-code”) may be calibrated to the specific additive manufacturing apparatus and may specify the precise location and amount of material that is to be formed at each stage in the manufacturing process. As discussed above, the formation of the micro-optical structures is through the TPP method, although other suitable form of additive manufacturing method may be used.

The code or instructions may be translated between different formats, converted into a set of data signals and transmitted, received as a set of data signals and converted to code, stored, etc., as necessary. The instructions may be an input to an additive manufacturing system and may come from a part designer, an intellectual property (IP) provider, a design company, an operator or an owner of the additive manufacturing system, or from other sources. An additive manufacturing system may execute the instructions to fabricate or form a micro-optical structure of the present embodiments using any of the technologies or methods disclosed herein.

Design files or computer executable instructions may be stored in a (transitory or non-transitory) computer readable storage medium (e.g., memory, storage system, etc.) storing code, or computer readable instructions, representative of the product to be produced. As noted, the code or computer readable instructions define the product that can be used to physically generate the object, upon execution of the code or instructions by an additive manufacturing system. For example, in the present embodiments, the instructions may include a precisely defined 3D model of a micro-optical structure and can be generated from any of a large variety of well-known computer aided design (CAD) software systems such as AutoCAD®, TurboCAD®, DesignCAD 3D Max, etc.

By controlling an additive manufacturing apparatus, such as a two-photon lithography system for use with the present TPP method, according to the computer executable instructions, the additive manufacturing apparatus can be instructed to print out or form one or more parts of the product. In the present embodiments, the micro-optical structure was formed in an assembled form, although it should be appreciated that in some embodiments, different sections (e.g. the reflective portion and the top lens) can be formed in an unassembled form. For instance, the reflective portion and the top lens may be printed separately and then subsequently assembled. This may be achieved using e.g. transfer printing methods. This may allow different treatments of the reflective portion and the top lens of a micro-optical structure, e.g. coating with different materials, or having them being made using different resins.

The additive manufacturing apparatus, for example the two-photon lithography system, may include a processor that is configured to automatically convert the design file into computer executable instructions for controlling the manufacture of the product. In these embodiments, the design file itself can automatically cause the production of the product once input into the additive manufacturing apparatus. Accordingly, in this embodiment, the design file itself may be considered computer executable instructions that cause the additive manufacturing apparatus to manufacture the product. Alternatively, the design file may be converted into instructions by an external computing system, with the resulting computer executable instructions being provided to the additive manufacturing apparatus. Given the above, the design and manufacture of implementations of the subject matter and the operations described in this specification can be realized using digital electronic circuitry, or in computer software, firmware, or hardware, including the structures disclosed in this specification and their structural equivalents, or in combinations of one or more of them. For instance, hardware may include processors, microprocessors, electronic circuitry, electronic components, integrated circuits, etc. Implementations of the subject matter described in this specification can be realized using one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. A computer storage medium (e.g. a computer readable medium storing computer executable instructions) can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

Although the TPP method described herein involves direct laser writing and subsequent development of a photoresin, it should be appreciated that use of other additive manufacturing technology which enable fabrication of complex objects by building objects point-by-point, layer-by-layer, may be possible and within the scope of the present disclosure. For example, any additive manufacturing technique which relates to the addition of material to form successive layers, or other manufacturing technology may be used.

It should be appreciated that the use of micro-optical structure or micro-scale light source is intended to cover dimensions ranging from hundreds of microns to sub-micron (e.g. tenth or hundredth of a micron). For example, sub 100 nm or 10 s of nanometers range can be achieved using the TPP method or using other wavelengths or manufacturing methods.

Although the above exemplary embodiments show micro-optical structures comprising a reflective cone and a top lens, it should be appreciated that in some embodiments, a micro-optical structure comprising a reflective portion can be used. The reflective portion may be a curved or a free-form reflector which is customizable based on requirements of the micro-scale light source (e.g. designs, dimensions, output etc.). In an embodiment, the reflective portion is tapered and may be in the form of a cone shape as shown in FIG. 2.

Other alternative embodiments include: (1) other form of light sources other than LEDs used in the aforementioned embodiments, such as VCSELs etc.; (2) micro-scale light sources emitting at a wide range of wavelengths (ranging from the near-UV to the infrared); (3) forming a micro-optical structure by molding using nano-imprinting, hot embossing, greyscale lithography or molding; (4) a micro-optical structure having an aspect ratio of a width to a height of the micro-optical structure ranges from 1:0.1 to 1:100. In this case, a micro-optical structure in the lower bound of this range, e.g. 1:0.1, may include a quasi-flat structure for capturing light emitted from sidewalls of a micro-scale light source, and a micro-optical structure in the higher bound of this range, e.g. 1:100, may include a tall structure; (5) optimizing dimensions or shapes of the reflective portion, or the reflective portion and the top lens based on maximizing a total intensity and/or minimizing a full width half maximum (FWHM) of the redirected light emitted out of the micro-optical structure; (6) a micro-optical structure being formed separately from a micro-scale light source, and subsequently attached or connected to the micro-scale light source; (7) forming a reflective portion or a reflective portion and a top lens of a micro-optical structure taking into account a geometry of the micro-scale light source for maximizing a total intensity and/or minimizing a full width half maximum (FWHM) of the redirected light emitted out of the micro-optical structure; (8) the top lens covering an entire top surface of the reflective portion or a portion of the top surface of the reflective portion; (9) a reflective portion of a micro-optical structure having a varying cross-section; (10) a slope of a reflective portion (from a bottom surface (closest to a micro-scale light source) to a top surface (closest to a top lens of the micro-optical structure)) of a micro-optical structure is not changing linearly (i.e. not a straight slope); (11) a micro-optical structure extends substantially normally (i.e. substantially perpendicularly) from an emitting surface of a micro-scale light source; and (12) a micro-optical structure extends at an angle (e.g. 30° to 45° or 30° to 60° or 30° to 90°) from an emitting surface of a micro-scale light source, for example a micro-optical structure can be designed to redirect light to somewhere on a plane of a chip (e.g. same plane as the emitting surface of the micro-scale light source) or towards the chip.

Although only certain embodiments of the present invention have been described in detail, many variations are possible in accordance with the appended claims. For example, features described in relation to one embodiment may be incorporated into one or more other embodiments and vice versa.

1. A micro-optical structure for a micro-scale light source having an emitting surface for emitting light, the micro-optical structure comprising:
a reflective portion formed on the emitting surface of the micro-scale light source,
wherein the reflective portion is adapted to reflect light emitted from the micro-scale light source out of the micro-optical structure.

2. The micro-optical structure of claim 1, further comprising a top lens formed on the reflective portion, wherein the reflective portion is adapted to reflect light emitted from the micro-scale light source towards the top lens, and the top lens is adapted to redirect the reflected light from the reflective portion to be emitted out of the micro-optical structure.

3. The micro-optical structure of claim 1, wherein the reflective portion is tapered or is adapted to operate based on total internal reflection or use of reflective coatings.

4. The micro-optical structure of claim 1, wherein the reflective portion comprises a compound parabolic concentrator (CPC).

5. (canceled)

6. The micro-optical structure of claim 1, wherein the reflective portion is divided into two or more sections adapted to provide different optical functions for light emitted from different portions of the micro-scale light source.

7. The micro-optical structure of claim 1, wherein a cross-section of the reflective portion includes one of: an octagonal shape, a square shape and a circular shape.

8. The micro-optical structure of claim 2, wherein the top lens includes one of: an anamorphic aspherical lens, a conical lens and a toroidal lens.

9. The micro-optical structure of claim 1, wherein the micro-optical structure extends substantially normally from the emitting surface of the micro-scale light source or is adapted to integrate with the micro-scale light source.

10. The micro-optical structure of claim 1, wherein an aspect ratio of a width to a height of the micro-optical structure ranges from 1:0.1 to 1:100.

11. The micro-optical structure of claim 2, wherein dimensions of the reflective portion and the top lens are optimized based on maximizing a total intensity and minimizing a full width half maximum (FWHM) of the redirected light emitted out of the micro-optical structure.

12. (canceled)

13. The micro-optical structure of claim 1, wherein
the reflective portion is adapted to enclose the emitting surface and exposed edge surfaces of the micro-scale light source.

14. A micro-scale optical system comprising a micro-scale light source and the micro-optical structure of claim 1, wherein the micro-optical structure is integrated with the micro-scale light source, or wherein the micro-scale light source includes one of: a light emitting diode (LED) and a vertical cavity surface emitting laser (VCSEL).

15. (canceled)

16. A computer readable medium storing computer executable instructions that, when executed by a processor, cause the processor to control an additive manufacturing apparatus to manufacture the micro-optical structure of claim 1.

17. A method for forming a micro-optical structure for a micro-scale light source having an emitting surface for emitting light, the method comprising:
forming a reflective portion of the micro-optical structure on the emitting surface of the micro-scale light source,
wherein the reflective portion is adapted to reflective light emitted from the micro-scale light source out of the micro-optical structure.

18. The method of claim 17, further comprising forming a top lens on the reflective portion, wherein the reflective portion is adapted to reflect light emitted from the micro-scale light source towards the top lens, and the top lens is adapted to redirect the reflected light from the reflective portion to be emitted out of the micro-optical structure.

19. The method of claim 18, wherein the reflective portion and the top lens are formed using a two-photon polymerization (TPP) process.

20. The method of claim 17, further comprising:
obtaining an electronic file representing a geometry of the micro-optical structure;
aligning an additive manufacturing apparatus for forming the micro-optical structure using a sidewall of the micro-scale light source; and
controlling the additive manufacturing apparatus to form, over one or more additive manufacturing steps, the micro-optical structure according to the geometry specified in the electronic file.

21. The method of claim 18, further comprising: forming the reflective portion and the top lens taking into account a geometry of the micro-scale light source for maximizing a total intensity and minimizing a full width half maximum (FWHM) of the redirected light emitted out of the micro-optical structure.

22. The method of claim 18, wherein the reflective portion and the top lens are formed using nano-imprinting, hot embossing, greyscale lithography or molding.

23. The method of claim 17, further comprising: forming the reflective portion to enclose the emitting surface and exposed edge surfaces of the micro-scale light source.
